(19) United States
(12) Patent Application Publication
(10) Pub. No.: US 2022/0147078 A1
(43) Pub. Date: May 12, 2022

(54) METHOD OF OPERATING AND CONTROLLING A GRILL

(71) Applicant: WOLF STEEL LTD., Barrie (CA)

(72) Inventors: Ichrak Inass El Abkari, Barrie (CA); Stephen Schroeter, Oro-Medonte (CA)

(21) Appl. No.: 17/453,970

(22) Filed: Nov. 8, 2021

Related U.S. Application Data
(60) Provisional application No. 63/111,335, filed on Nov. 9, 2020.

(51) Int. Cl. G05D 23/19; F24C 3/12; F24C 7/08; A47J 37/07; A47J 36/32; A23B 4/052; A23L 5/10

(52) U.S. Cl. CPC G05D 23/1931; F24C 3/12; F24C 7/08; A47J 37/0709; A23V 2002/00; A47J 36/32; A23B 4/052; A23L 5/15; A23L 5/17; A47J 37/0713

(57) ABSTRACT

A method of operating and controlling a grill includes the steps of activating a master control to connect a heat control system of the grill with an external source of energy, and determining whether an element or burner control is an “on” position. If the determination confirms that an element or burner control is in an “on” position, a visual indication is provided to identify the particular element or burner control that is in the “on” position. If the determination confirms that an element or burner control is in an “on” position, activation of an associated heating element or burner is prohibited.

### CROSS-REFERENCE TO RELATED APPLICATION(S)

This application claims the benefit of U.S. Provisional Application No. 63/111,335 filed Nov. 9, 2020, for “Method of Operating and Controlling a Grill” by Ichrak Inass El Abkari and Stephen Schroeter, the contents of which are incorporated herein by reference.

### TECHNICAL FIELD

This disclosure relates to grills, and in one embodiment to a method of operating and controlling a grill.

### BACKGROUND

Barbecues or grills have been used for the preparation of human food for centuries. In more recent times grilling has taken on an entertainment function and has become part of the social fabric of many societies, where the preparation of food on a grill is a focal point of a get together of family and friends. Modern grills have thus become sophisticated and elaborate devices that are, in many instances, designed to enhance the experiences of the user, beyond the simple cooking of food.

Many of the grills in current use rely upon the combustion of a fuel source to generate heat. Some of the most common fuel sources that are used include natural gas, propane, charcoal, and wood pellets. In each instance the fuel source is ignited, causing the generation of heat that is then used to cook food.

More recently the use of electric grills, that generate heat through passing an electrical current through a resistive heating element, have experienced a resurgence. Grills that that rely upon the combustion of a fuel source create combustion by-products, which can include noxious gases, undesirable greenhouse gases, and in some cases ash or other solid combustion waste products. Because of the presence of combustion, there also exists the risk of potential fire. Where the fuel source is natural gas or a liquid hydrocarbon, explosion is possible. For these reasons, many jurisdictions place limitations on the use of “combustion-type” grills under certain applications. For example, the use of fuel-burning grills may be prohibited in multi-story buildings, such as apartments and condominiums, where even a small risk of fire or explosion may be unacceptable. In some areas where the availability of hydrocarbon or other fuel sources for grills may not be plentiful, the operational costs of fuel-burning grills may also be a deterrent to their use. The result of the above is that electric grills, once being only sparsely used, have become increasingly common.

While fuel burning, and more recently electric, grills have become tremendously popular they each suffer from a number of inherent problems that can detract from the grilling experience of the user, that can result in enhanced energy consumption, and that in some cases can represent a safety hazard.

For example, in the case of a gas grill, turning on the main gas supply when one of the controls for an individual burner is in the “on” position can present safety issues if the individual is unaware of the “on” control. In such instances a supply of gas could build up within the grill and present an explosion hazard. Where the grill is an electric grill, its main power switch could be accidentally turned on, or in some cases turned on by a child. If a burner control were in an “on” position in such a situation the related electric element would be energized, resulting in a waste of electricity and creating a potential fire hazard.

Further, the potential for grease fires is significant in all types of grills. Grease fires can not only destroy food that is being cooked on a grill, but can also be a source for the transmission of the fire to surrounding objects and structures, and can represent a safety concern.

There is therefore a constant need to improve the operational control of grills, whether they be fuel burning or electric, in order to help reduce energy consumption, to enhance the experience of the user, and/or to help reduce the potential for fire, explosion, injury, and damage to property.

### SUMMARY

Accordingly, in one aspect the present disclosure provides a method of operating and controlling a grill, the method comprising the steps of activating a master control to connect a heat control system of the grill with an external source of energy; upon the activation of the master control, determining whether an element or burner control of the grill is an “on” position; wherein, if said determination confirms that an element or burner control is in an “on” position, providing a visual indication to identify, to a user, the particular element or burner control that is in an “on” position, and wherein, if said determination confirms that an element or burner control is in an “on” position, prohibiting the activation of an associated heating element or burner without intervention by the user.

In further aspect there is provided a method of operating and controlling a grill having one or more heating elements or burners, the method comprising the steps of determining a maximum operating temperature for the grill; determining a maximum rate of increase of the operating temperature of the grill; measuring the operating temperature of the grill; measuring any rate of increase in the operating temperature of the grill; comparing the measured operating temperature to the determined maximum operating temperature; comparing any rate of increase in operating temperature of the grill to the determined maximum rate of increase of the operating temperature of the grill; deactivating the one or more heating elements or burners of the grill should the measured operating temperature exceed the predetermined maximum operating temperature; and deactivating the one or more heating elements or burners of the grill if a measured increase in operating temperature exceeds the predetermined maximum rate of increase in operating temperature.

Further aspects of the present disclosure will become apparent from the following description taken together with the accompanying drawings.

### BRIEF DESCRIPTION OF THE DRAWINGS

For a better understanding of the present disclosure, and to show more clearly how it may be carried into effect, reference will now be made, by way of example, to the accompanying drawings which show exemplary embodiments of the present disclosure in which:

FIG. 1 is an upper side perspective view of an electric grill employing a method of operation and control in accordance with an embodiment of the present disclosure.

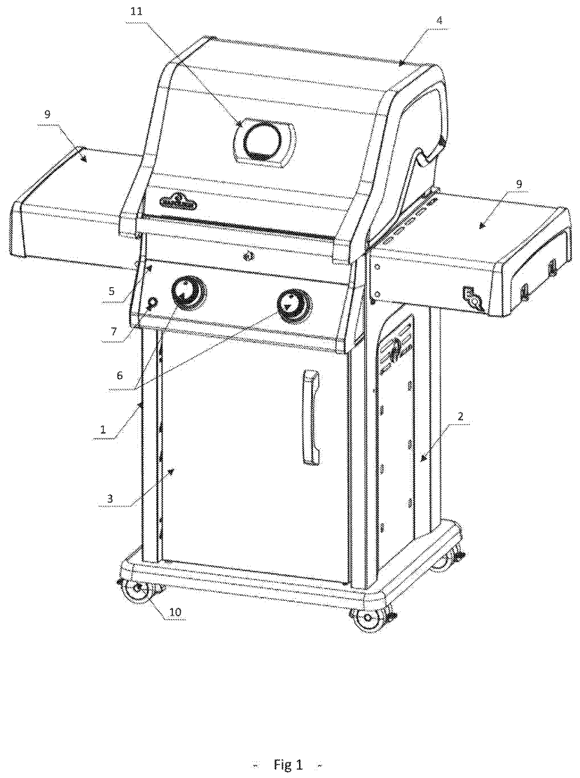

FIG. 2 is a view similar to FIG. 1 wherein the lid of the grill is in its open position.

FIG. 3 is a front elevational view of the grill shown in FIG. 2 wherein the lower door of the grill cabinet is in its open position.

FIG. 4 is a partial upper perspective view of the grill of FIG. 1 with the lid in its open position and with the searing grills removed showing the heating elements.

FIG. 5 is a view similar to FIG. 4 demonstrating rotation of the heating elements for grill cleaning purposes.

FIG. 6 is a schematic drawing of a number of the primary electrical components of the grill of FIG. 1.

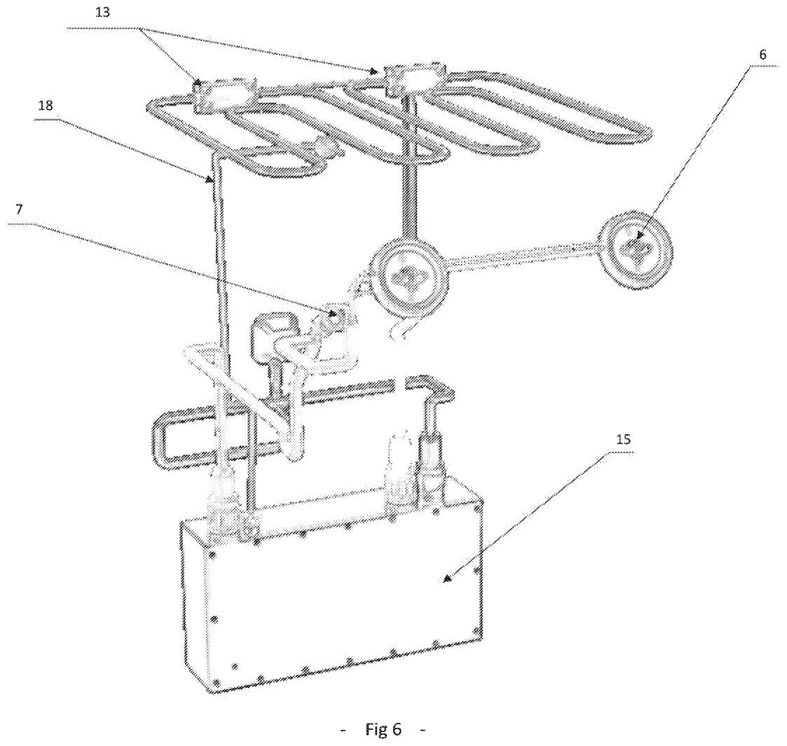

FIG. 7 is a flow chart showing the general operational logic of a grill constructed in accordance with an embodiment of the present disclosure as it relates to an electric grill.

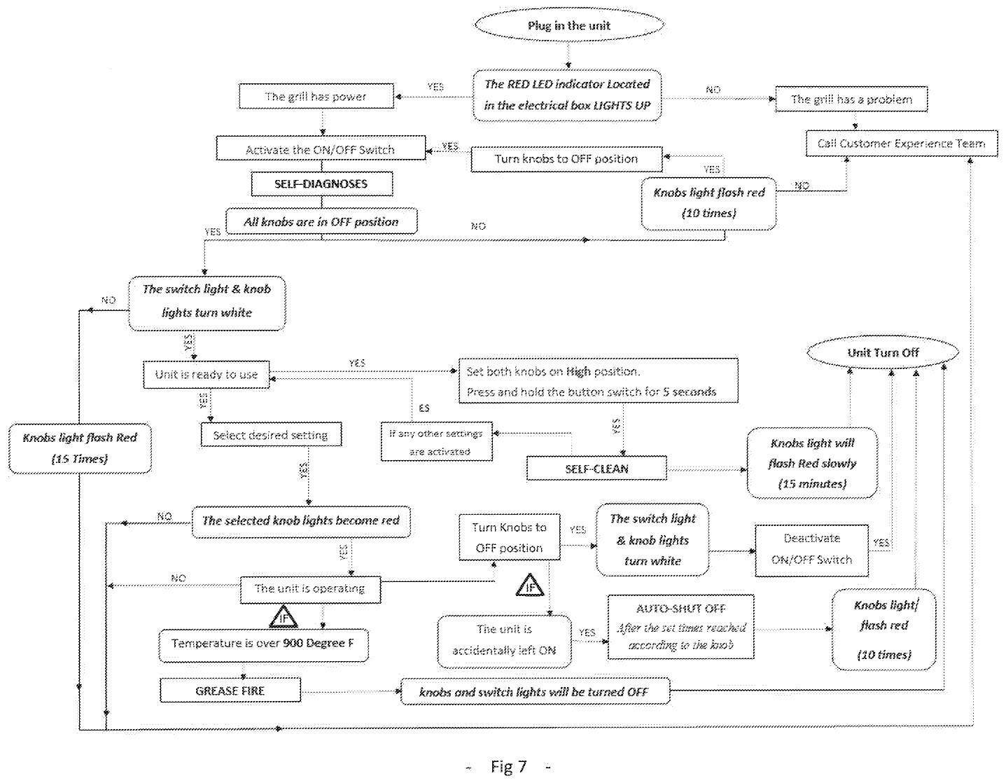

FIG. 8 is an upper side perspective view of an alternate embodiment of the electric grill shown in FIG. 1.

### DETAILED DESCRIPTION

The present disclosure may be embodied in a number of different forms. The specification and drawings that follow describe and disclose some of the specific forms of the present disclosure.

For illustration purposes the attached drawings depict an electric grill 1 that utilizes a method in accordance with an embodiment of the present disclosure. From a thorough understanding of the present disclosure it will be appreciated that the described method of operation and control can be adopted to apply to a variety of different types of grills, including electric and gas grills. The operational steps that are described apply to both electric and gas grills, with minor modifications in some instances to account for specific components that are unique to one form of grill or the other. Nevertheless, the described methodology is applicable to both gas and electric grill.

In the case of the electric grill shown in the attached drawings, many of the particular components and structure of the grill are not necessarily unique to the present disclosure. Other grill designs and configurations could be utilized. In the particular embodiment that is shown, a grill 1 is comprised generally of a main cabinet 2 having a cabinet door 3 and a lid 4. A control surface 5 provides a means to locate element or burner controls which will typically comprise control knobs 6. The function of the element or burner controls will be to permit, regulate, and disrupt or deactivate the supply of energy to associated burners or elements, depending on the operational position of the element or burner controls. Where electric elements are in use, the element or burner controls will supply, regulate, and disrupt or deactivate the flow of electricity to the electric elements. Where gas burners are in use, the element or burner controls will supply, regulate, and disruptor deactivate the flow of gas to the gas burners. In the case of electric elements, it is expected that in most instances the element or burner controls will be knobs 6, that will typically be potentiometers. Control surface 5 may also house a master control or master power switch 7 at a convenient position and angle for use by an operator. Where the gill is a gas grill it will be appreciated that master control 7 may comprise the main gas supply valve that delivers gas to the grill and control knobs 6 may be gas controls that regulate the flow of gas to individual burners. It should also be noted that many standard features of a grill could be incorporated into grill 1, including side shelves 9, casters 10, and a thermometer 11.

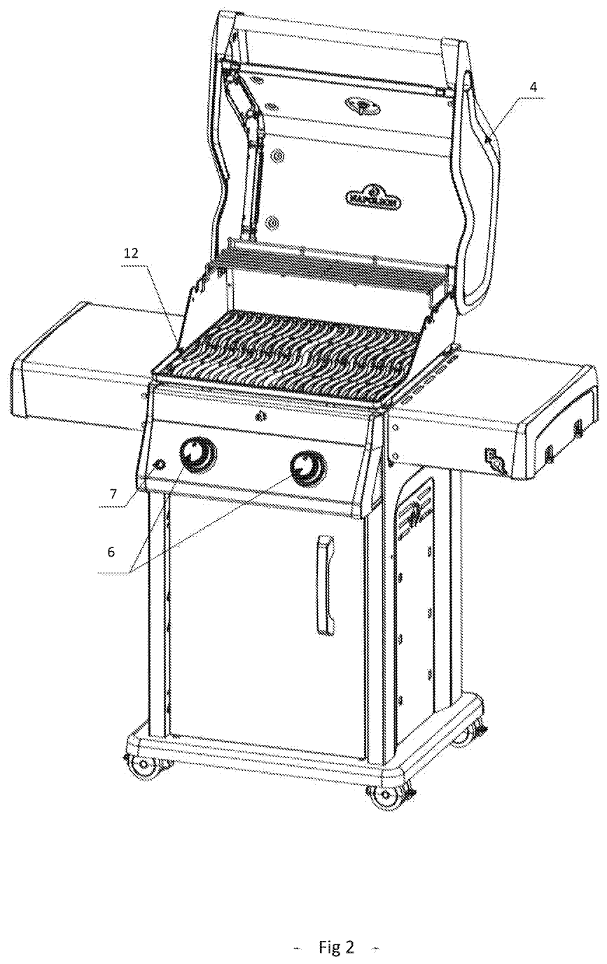

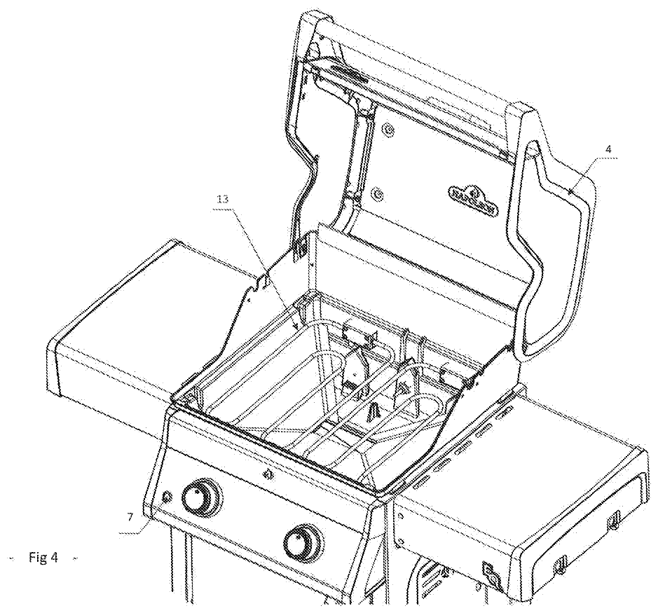

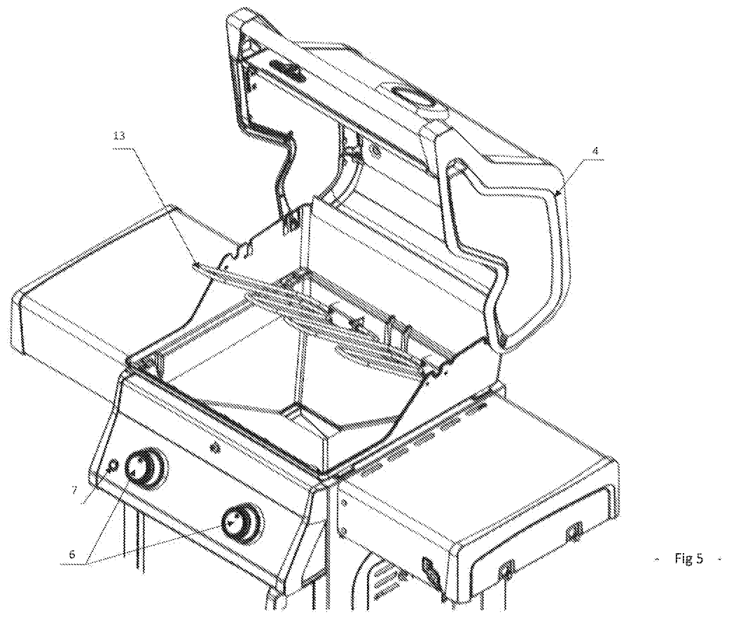

FIGS. 2 through 5 show additional aspects and features of grill 1, some of which are unique to an electric grill and others of which are common to both gas and electric grills. In FIG. 2, lid 4 has been opened showing grilling grates 12. In FIG. 4, grates 12 have been removed to illustrate electric heating elements 13. It is expected that in most instances elements 13 will be relatively standard electric resistive heating elements and that one or more elements may be utilized, largely depending upon the size and intended use of the grill. FIG. 5 shows the ability to rotate elements 13 from a generally horizontal to an inclined or vertical position to help facilitate the cleaning of interior components of the grill.

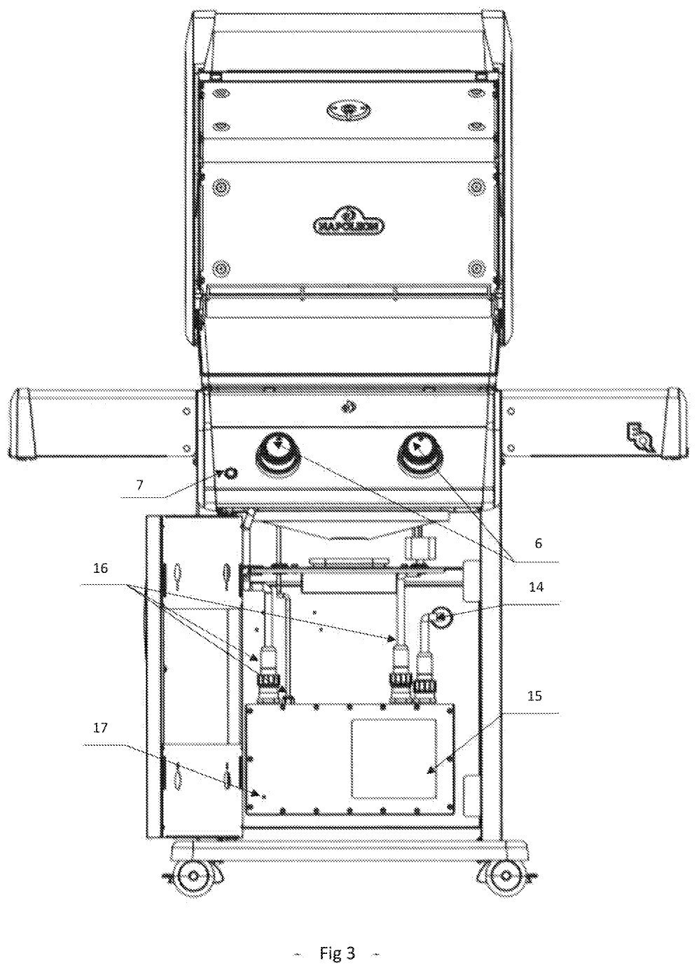

In FIG. 3, cabinet door 3 has been opened to show a number of the interior functional components of a grill. Since in the example that is shown grill 1 is an electric grill, it may include a main power supply 14 that feeds electricity to a control box or control module 15 which will in many cases contain a number of the control circuitry, relays, control logic, microprocessor, and/or other electrical control and operational components and structures. Power delivery and control cabling 16 deliver electricity to and from knobs 6, master power switch 7, elements 13, and one or more temperature sensors. Control box or control module 15 may include a light 17 to indicate that electricity is being supplied to grill 1. Grill 1 may be designed and fabricated for use with different electrical voltages, depending upon the standard voltage of the jurisdiction in question. It will be appreciated that where the grill is a gas grill, the electrical cabling will be typically replaced with gas piping or hoses, potentiometers to control the delivery of electricity will be replaced with gas valves, etc.

For purposes of this description, it will be appreciated that when an element or burner control is in its “on” position it will be positioned or configured to permit electricity to “flow” to one or more heating elements or to permit gas to be directed to one or more burners. Similarly, an element or burner control is in its “off” position it will be positioned or configured to prohibit the flow of electricity to associated heating elements or the flow of gas to one or more burners. It will also be appreciated that “activation” of a heating element or burner within the present context refers to the delivery of electricity to one or more heating elements or the delivery of gas to one or more burners.

In accordance with the present disclosure, there is provided a method of operating and controlling electric grill 1. Under the method, with the grill connected to a source of external energy (in this case electricity, but in the case of a gas grill to a source of natural gas or propane), an operator will first activate master power switch or control 7 to place the grill in an “on” position. Upon activation of master power switch 7, a microprocessor control (typically housed within control box 15) undertakes a diagnostic process where it will determine the status of the control knobs, and specifically whether one or more of control knobs 6 are in their “on” position. If the determination of the status of the control knobs confirms that one or more of the control knobs are in an “on” position, a visual indication of the particular knob or knobs that are in an “on” position will be provided to the user. In most instances it is expected that the visual indication will be the activation of a light source of a predetermined color (for example red) where the light source is integrated into the control knob itself or is a separate light source that is in a close vicinity to the particular control knob of concern. In other embodiments, a schematic of the heating elements could be integrated into control surface 5 with a light source activated to geometrically convey to a user that one or more particular control knobs are in their “on” position. Appreciated modifications to particular components of the grill will be made to enable the described method where the grill is a gas grill.

In accordance with an embodiment of the present disclosure, upon activation of the master control (ie a master power switch where electric elements are used or a gas valve where gas burners are used), should it be determined that a control knob is in its “on” position, control module 15 will prohibit the delivery of electricity (or gas as the case may be) to the heating element or burner associated with that particular control knob until the knob is moved to its “off” position. Similarly, if upon activation of the master control it is determined that a control knob is in its “off” position the delivery of electricity (or gas as the case may be) to the associated heating element or burner will be permitted when the control knob is moved from its “off” to its “on” position. That is, when the master control is first activated, should an element or burner control be found to be in an “on” position, the activation of an associated heating element or burner is prevented without intervention by the user.

Operating and controlling a grill in this fashion thus prevents the unintended heating of one or more of the elements 13 (or burners) should master power switch 7 (or main gas supply valve) be moved to its “on” position unintentionally or accidentally. If a control knob is left in its “on position”, activation of the main power switch will not result in the generation of heat by the related heating element until such time as the knob is (i) first moved to its “off” position and, thereafter, (ii) subsequently moved from its “off” to its “on” position. A similar operational control methodology prevents the delivery of gas to a gas burner when the main gas supply valve is turned “on” should a control knob for an individual burner have been left in an “on” position.

In embodiments of the present disclosure, the control knobs may be designed to emanate different colors of light, depending upon their position and degree of activation. For example, a particular color light could be displayed when the grill has been turned “on”, but wherein a control knob is “off” such that no electricity (or gas) is sent to the associated heating element (or burner). Thereafter, different colors of light could be generated depending on the level of electricity (or gas) delivered to the heating element and the associated level of heat that is being generated (from low to high). Where the grill control and logic includes a “cleaning” procedure (wherein high heat is generated to burn off grease and food particles) a different color of light may be generated or other visual indicators may be provided to advise the operator that a high heat situation is in process.

In accordance with one aspect of the present disclosure, there may also be provided a means by which control module 15 automatically stops the delivery of electricity (or gas in the case of a gas grill) to a particular heating element (or burner) after a predetermined time. Such a feature provides an automatic shut off should the grill be left unattended and in an “on” position for a length of time that could present a potential safety hazard or an excessive consumption of energy. It is expected that in most instances the predetermined time will be determined according to, and will be a function of, the relative heat output of the heating element (or burner) associated with a particular setting on the related control knob. Further, in one embodiment, the predetermined time associated with a low heat output setting on a control knob will be greater than the predetermined time associated with a high heat output setting. Such can be advantageous in situations where a user wishes to operate the grill at a relatively low setting for an extended length of time to slowly cook food. Further, such a control methodology takes into account the fact that individuals will not typically and intentionally operate a grill at a high heat setting for an extended period of time. Where such a situation exists, in many instances it would be indicative of a control knob unintentionally left in a high heat setting when the grill is left unattended.

In an embodiment of the present disclosure there is also provided a method of operating and controlling a grill that is particularly adapted to situations of a grease fire. The aroma and flavour formed from smoke that is created from fat dripping onto a heated element or burner is desirable by many individuals when cooking food on a grill. As a result, many “grilling” cuts of meat, in particular, include a generous amount of fat. A downside of grilling high-fat foods is that the fat drippings can at times cause grease fires. Such fires cannot only overcook or burn food on the grill, but can also be a safety concern.

In accordance with an embodiment of the present disclosure a safe maximum operating temperature for the grill is determined. Further, there is determined a safe rate of the increase of the temperature within the grill. That is, based upon the size of the heating elements or burners, the overall size of the grill, the rate of heat loss for the grill, etc., a safe maximum rate of temperature increase within a grill can be determined. The disclosed method thus includes a means to measure and monitor the temperature of the grill and to measure and monitor the rate of increase in temperature of the grill. Both the grill's temperature and its rate of temperature increase can then be compared with the predetermined safe maximum operating temperature and the predetermined safe maximum rate of temperature increase. A measured temperature that exceeds the safe maximum operating temperature (for example 900 degrees F)and/or a measured rate of temperature increase that exceeds the safe maximum rate of temperature increase can thus be indicative of a grease fire and a potentially dangerous operating condition. At that point the delivery of electricity to the heating elements (or the delivery of gas to burners) can be interrupted to deactivate the elements (or burners) in an attempt to reduce the source of ignition of the grease and to reduce the overall temperature of the grill until such time as the grease fire either burns itself out or is otherwise controlled or extinguished. It may also be desirable to provide a visual and/or audio indicator of an excessive temperature or excessive rate of temperature increase to warn an operator of a potential grease fire condition.

It will be appreciated that the method of operating a grill described herein is one embodiment specifically associated with the operation of an electric grill having one or more electric heating elements. As discussed, in an alternate embodiment the method could be applied to an gas grill equipped with one or more gas burners that operate using natural gas or propane. In a further alternate embodiment a combination of electric elements and gas burners could be utilized. With adaptations to physical controls the described method would operate essentially the same. That is, if a control or control knob is detected to be in an “on” position prior to turning on the main gas supply valve that delivers gas to the grill, the method could prevent the main gas supply valve from being operated and/or from delivering gas to the grill in general or to individual burners until all control knobs are in their “off” positions. It is expected that in most instances the incorporation of electrically controlled valves in the gas supply system of the grill would be required to accomplish that function. Similarly, if a maximum safe operating temperature is detected or the maximum safe rate of temperature increase is exceeded, the supply of gas to the burners could be interrupted to thereby deactivate the burners in a suspected grease file scenario. Once again, in most instances it is expected that accomplishing such will be through the incorporation of electrically controlled gas valves and controls. The supply of gas to a burner could also be interrupted to deactivate the burner after a defined time, where that time is a function of the heat setting of the control for the burner in question.

In a further embodiment, the method of operating and controlling a grill may include one or more of three distinct cooking modes, comprising a grill mode, an oven mode, and a smoker mode. In the grill mode, control knobs 6 (which typically independently control separate electric elements where the grill is an electric grill, or separate gas burners where the grill is a gas burning grill) will operate much like many conventional grills, controlling to flow of electrical current or gas to the elements or burner.

The same grill may also include an oven mode, wherein the grill may be fitted with one or more internal thermostats or temperature sensors or thermocouples 18 that trigger or control heating cycles for one or more electric heating elements 13, and/or one or more gas burners where the grill is fitted with gas burners. The control of the electrical elements/gas burners maintains the internal grill temperature at or near a temperature that is set by an operator. In one embodiment, two thermostats 18 may be utilized and positioned at different locations within the grill, horizontally and/or vertically off-set from one another. When in the “oven” mode, temperature readings from the one or more thermostats or temperature sensors are directed to control box or module 15, where a predetermined algorithm can be applied to the readings to take into account the sensed temperature at different locations within the grill, and to thereby activate or deactivate one or more electric heating elements/gas burners. The elements/burners will thus be cycled on and off and/or their output increased or decreased as needed to help maintain the internal temperature within the grill near the set point entered by the operator. The algorithm applied to temperature readings taken at different locations will help to maintain a consistent temperature profile across the entirety of the internal enclosure of the grill. For example, where one side of the grill is subjected to significant cooling effects by a strong wind, control module 15 can operate to cycle the heating element/gas burner on that side of the grill more often, for longer periods of time, or at a higher intensity, to account for the cooling effect. The operation of the grill in this mode may also be conducted remotely through use of a smart phone or other wireless device.

In its “smoker mode”, the grill may be fitted with multiple heating elements and/or gas burners, where one or more of the elements/burners are used to control the cavity temperature within the grill, while one or more other elements/burners are used to ignite or heat a consumable product (for example wood or pellets) to create a source of smoke. In this embodiment, the grill may be fitted with a tray or similar structure into which can be loaded wood chips or other consumable products that produce an aromatic smoke within the interior of the grill when ignited or heated by a heating element or burner of the grill. Control module 15 may operate the heating elements/burners independently in accordance with a function consistent with a “smoker”. In one embodiment, one or more elements/burners may be controlled by one or more thermostats or temperature sensors 18 as described above in order to help maintain a relatively consistent temperature profile across the internal grill cavity. At the same time, one or more elements/burners independently provide a source of heat or ignition to the consumable product that forms the smoke, causing that product to burn or char at a rate that is sufficient to produce a desired degree of smoke within the grill cavity. In some instances the grill may also include optical sensors to transmit data to control module 15 indicating the level or extent of smoke within the internal cavity of the grill. That data may then be used to cycle the element/burner associated with the consumable product forming the smoke, control the length of time the element/burner is activated, or control the intensity of the heat produced by the element/burner. There is thus created an automated system that not only maintains a desired temperature within the grill cavity, but that also maintains a desired level of aromatic and flavour inducing smoke. Once again the automated system can be designed to react to external effects, such as exposure of the grill to wind, in order to help maintain a consistent environmental profile across the interior of the grill.

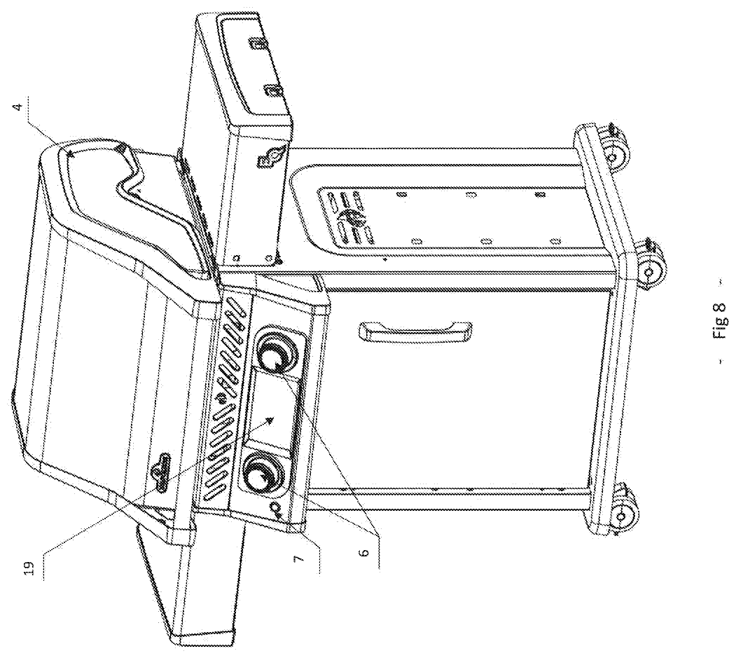

It will be appreciated by those of skill in the art that departures from the embodiments described above are possible while remaining within the scope of the present disclosure as it is contemplated by the inventors. For example, grill 1 may be equipped with a touchscreen control panel 19 to assist in the control and/or programming of functions of the grill. The touchscreen control could replace the more traditional control knobs, or could be used to augment their function (See FIG. 8). The touchscreen panel may also display current grill functions and operating parameters, such as internal temperature, a countdown time to an estimated time to complete a cooking operation, the “mode” of the grill (grilling, oven or smoker), etc.

Touchscreen panel 19 may include visual warning symbols or signals to alert a user to the condition of an element (its temperature setting, etc), to a potential grease fire situation where a rapid rise in temperature or an exceedingly high temperature is sensed, to an element or burner that may have been inadvertently left on, and to other such safety or informational matters. Further, the touchscreen functions may be accessed remotely and displayed remotely on a smart phone or other device through a Wi-Fi or other wireless connection.

It will also be appreciated that in an embodiment of the present disclosure, rather than having the control knobs and/or touchscreen panel being connected directly the high voltage supply and components of the grill, grill 1 may include a low voltage control module which processes inputs from the control knobs and/or touchscreen panel and sends corresponding signals to a control board in control module 15 that, in turn, controls or operates the high voltage functions of the grill. In this manner, high voltage may be isolated from the user input devices, making them inherently safer, and also simplifying their structure as they need not be designed to be capable of handling the level of voltage that is supplied to the elements.

It is to be understood that what has been described are the preferred embodiments of the present disclosure. The scope of the claims should not be limited by the preferred embodiments set forth above, but should be given the broadest interpretation consistent with the description as a whole.

We claim:

1. A method of operating and controlling a grill, the method comprising the steps of:
activating a master control to connect a heat control system of the grill with an external source of energy;
upon activation of the master control, determining whether an element or burner control of the grill is an “on” position;
wherein, in response to said determination confirming that an element or burner control is in an “on” position, providing a visual indication to identify, to a user, the particular element or burner control that is in an “on” position, and
wherein, in response to said determination confirming that an element or burner control is in an “on” position, prohibiting the activation of an associated heating element or burner without intervention by the user.

2. The method as claimed in claim 1, wherein the visual indication comprises activation of a light source of a predetermined color.

3. The method as claimed in claim 2, further comprising providing each element or burner control with one or more light sources, each element or burner control generating light of a first color when the master control is activated and the respective element or burner control is in an “off” position, and each element or burner control generating light of a second color when the master control is activated and the element or burner control is in an “on” position.

4. The method as claimed in claim 1, comprising a further step of disrupting supply of external energy to the element or burner after a defined time, the defined time being predetermined according to a heat output of the element or burner associated with a particular setting of the associated element or burner control.

5. The method as claimed in claim 4, wherein the predetermined time associated with a low heat output setting is greater than the predetermined time associated with a high heat output setting.

6. The method as claimed in claim 1, wherein the grill is an electric grill, the master control is a master power switch, and wherein the step of prohibiting the activation of the associated heating element or burner comprises prohibiting delivery of electricity to the heating element associated with the element or burner control that is in an “on” position.

7. The method as claimed in claim 1, wherein the grill is a gas burning grill, the master control is a main gas supply valve, and wherein the step of prohibiting the activation of the associated heating element or burner comprises prohibiting delivery of gas to the gas burner associated with the element or burner control that is in an “on” position.

8. The method as claimed in claim 1, including operating the grill in a grill mode, an oven mode, or a smoker mode,
wherein, in the oven mode, elements or burners of the grill are operated to maintain an internal temperature of the grill at or near a predetermined temperature,
wherein, in the grill mode, the elements or burners of the grill are operated to selectively increase or decrease a level of heat applied to different areas within the grill, and
wherein, in the smoker mode, the grill is operated to maintain a temperature within the grill at or near a predetermined temperature, and at least one element or burner is operated to ignite or to heat a combustible substance to form smoke within the grill.

9. The method as claimed in claim 8, wherein the grill includes at least two temperature sensors to record the internal temperature of the grill at different locations, the method further comprising:
directing temperature signals from the temperature sensors to a control module, the control module applying an algorithm to the temperature signals and controlling operation of one or more elements or burners to help maintain the internal temperature of the grill at or near the predetermined temperature and to help maintain a consistent temperature profile across a cooking area of the grill.

10. The method as claimed in claim 8, wherein the grill includes an internal optical sensor, the internal optical sensor directing a signal to a control module indicative of a level of smoke within the grill, the control module utilizing the signal from the optical sensor to operate the at least one element or burner used to ignite or to heat the combustible material in a manner that helps to maintain a predetermined level of smoke within the grill.

11. A method of operating and controlling a grill having one or more heating elements or burners, the method comprising the steps of:
determining a maximum operating temperature for the grill;
determining a maximum rate of increase of operating temperature of the grill;
measuring operating temperature of the grill;
measuring any rate of increase in operating temperature of the grill;
comparing the measured operating temperature to the determined maximum operating temperature;
comparing the measured any rate of increase in operating temperature of the grill to the determined maximum rate of increase of operating temperature of the grill;
deactivating the one or more heating elements or burners of the grill in response to the measured operating temperature exceeding the predetermined maximum operating temperature; and
deactivating the one or more heating elements or burners of the grill in response to the measured increase in operating temperature exceeding the predetermined maximum rate of increase in operating temperature.

12. The method as claimed in claim 11, including a further step of activating a visual and/or audio indicator in response to the measured operating temperature exceeding the determined maximum operating temperature or in response to the measured rate of increase in operating temperature exceeding the determined maximum rate of increase in operating temperature.

13. The method as claimed in claim 11, wherein the grill is an electric grill and the one or more heating elements or burners are electric heating elements, the step of deactivating the one or more heating elements or burners of the grill comprising interrupting delivery of electricity to the one or more electric heating elements.

14. The method as claimed in claim 11, wherein the grill is a gas grill and the one or more heating elements or burners are gas burners, the step of deactivating the one or more heating elements or burners of the grill comprising interrupting delivery of gas to the one or more gas burners.

15. The method as claimed in claim 11, comprising the further step of deactivating a heating element or burner after a defined time, the defined time being predetermined according to a heat output associated with a particular setting of an element or burner control that operates the heating element or burner.

16. The method as claimed in claim 15 wherein the predetermined time associated with a low heat output setting is greater than the predetermined time associated with a high heat output setting.
